(19) United States
(12) Patent Application Publication
(10) Pub. No.: US 2014/0045969 A1
(43) Pub. Date: Feb. 13, 2014

(54) Curable Composition

(71) Applicants: Simone Klapdohr, Rosenheim (DE); Jochen Mezger, Lautersheim (DE); Burkhard Walther, Garching (DE); Helmut Mack, Traunstein (DE)

(72) Inventors: Simone Klapdohr, Rosenheim (DE); Jochen Mezger, Lautersheim (DE); Burkhard Walther, Garching (DE); Helmut Mack, Traunstein (DE)

(73) Assignee: Construction Research & Technology GmbH, Trostberg (DE)

(21) Appl. No.: 13/989,157

(22) PCT Filed: Nov. 25, 2011
(86) PCT No.: PCT/EP11/70999

§ 371 Date: Jul. 10, 2013

(30) Foreign Application Priority Data
Dec. 3, 2010 (EP) 10193625.0

(51) Int. Cl. C09J 11/06

(52) U.S. Cl. CPC C09J 11/06
USPC 523/122; 525/455; 524/590; 502/167

(57) ABSTRACT

The invention relates to a composition comprising (A) at least 5% by weight of en organic prepolymer P having at least two water-crossilnkable organosilicon end groups, (B) 0.01% to 3.0% by weight of boric acid and/or bone ester, and (C) 0.01% to 3.0% by weight of an amine component. Additionally disclosed is a method for the curing of these compositions and also the use of boric acid and/or boric esters and an amine component a condensation catalyst.

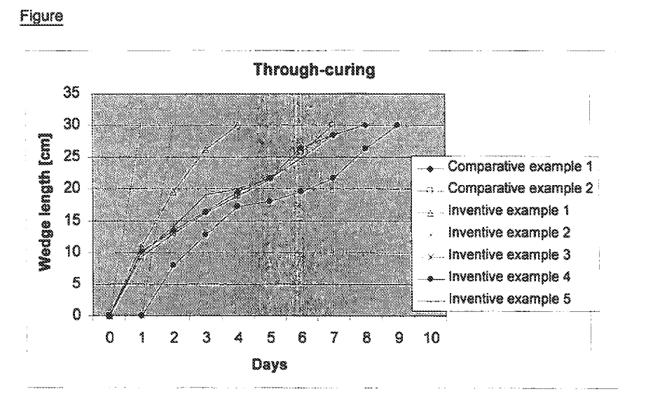

The present invention relates to a composition comprising organic prepolymers having at least two water-crossilnkable organosilicon end groups, boric acid and/or boric ester, and an amine component. Additionally disclosed is a method for the curing of these compositions and also the use of boric acid and/or boric esters and an amine component as condensation catalyst.

Curable polymer systems which possess reactive organosilicon end groups, more particularly alkoxysilyl groups, are known. In the presence of atmospheric moisture, which diffuses into the material to be cured, and in the presence of catalysts, alkoxysilane-terminated polymers are capable even at room temperature of undergoing condensation with one another with elimination of the alkoxy groups. The parent structure of the curable polymer systems may be, for example, acrylates, polyurethanes, polyureas, colycarbonates, polyethers and polyesters. Depending on the amount of alkoxysilyl groups and their structure, the systems form long-chain polymers (thermoplastics), relatively wide-meshed, three-dimensional networks (elastomers) or highly crossilnked systems (thermosets).

For years, moisture-curing adhesives and sealants, and also varnishes and coatings, have played a significant part in numerous technical applications. Adhesives and sealants based on silylated polyurethanes, examples being SPUR® polymers from Momentive Performance Materials Inc., Desmoseal® from Bayer Materiel Science AG, silylated polyureas; silyl-terminated polyethers, e.g. MS-Polymer® from Kaneko Corp., ST polymers from Hanse Chemie AG and α,ω-silyl-terminated acrylates, or acrylate telecheles, e.g. X-MAP® from Kaneka Corp, and silylated polysulphides have a very broad spectrum of application, and are used in formulations that are adapted to the particular end use, such as, for example, in civil engineering and construction, in the aircraft or automotive industries, and in shipbuilding. These adhesives and sealants are notable more particularly for a broad adhesion spectrum to a large number of substrates without surface pre-treatment by primers.

Typical catalysts for the curing of polymers with organosilicon end groups and especially alkoxysilane-terminated polymers are tin catalysts. However, there are many other catalysts that are also suitable.

WO 2009/021928 A1 is concerned with silane-crosslinking curable compositions and the use thereof in adhesives and sealants. As catalysts for controlling the cure rate, organometallic compounds in particular are cited, such as those of titanium, iron, bismuth, zirconium, aluminium and tin. Additionally, acidic compounds such as phosphoric acid, p-toluenesulphonic acid and amines. Other curing catalysts disclosed are boron halides.

In order to avoid the use of tin compounds as a curing catalyst for adhesives and sealants, and in order, after curing has taken place, to obtain particularly good elasticity and stretchability, WO 2009/133062 proposes a method in which first a difunctonal organic polymer is reacted with an organofunctional silane. The resulting prepolymer is subsequently mixed with a silane condensation catalyst, selected from the group consisting of compounds of elements from main group three and/or from transition group four, and heterocyclic organic amines, amine complexes of the element compounds or mixtures thereof and also, if desired, further compounds.

In the context of adhesive bonding methods and techniques, the term “open time” refers to the interval from the beginning of application of the adhesive until the adherends are joined, within which an optimum adhesive bond is still obtained. Exceeding this time results in poorer mechanical properties on the part of the adhesive bond. With the catalysts known from the prior art, the prepolymer terminated with organosilicon end groups begins to react immediately in the presence of water. This reaction is accompanied by a rapid increase in viscosity. For many applications, however, it would be advantageous to be able to set a longer open time with the same viscosity, within which the material could be processed with consistent quality. Subsequently, after a certain point in time, very rapid curing ought to take place, so that the material can quickly be used for its actual intended purpose or so that further operations or construction steps (such as subsequent coatings, for example) can be performed.

It was an object of the present invention, therefore to provide a curable composition which after activation possesses a long open time within which the composition has a consistent viscosity, and subsequently cures very rapidly. In this context, depending on the intended use, it ought to be possible to set the open time within boundaries that are as wide as possible. Furthermore, the cured compositions obtained as a result ought to have good mechanical properties, more particularly good elasticity and stretchability. The compositions, furthermore, should be free from tin compounds.

This object has been achieved by means of a composition comprising

(A) at least 5% by weight of an organic prepolymer P having at least two water-crosslinkable organosilicon end groups,

(B) 0.01% to 3.0% by weight of boric acid and/or boric ester, and

(C) 0.01% to 3.0% by weight of an amine component.

In one preferred embodiment, the prepolymer P comprises organosilicon end groups of the formula (I),

—Y—R¹—Si(R³)ₙ(OR²)₃₋ₙ (I)

where Y is represented by a divalent linking group,

R¹ is represented by a divalent hydrocarbon unit having 1 to 10 carbon atoms,

OR² is identical or different and independently at each occurrence is represented by an alkoxy group, where R² is an alkyl group having 1 to 10 carbon atoms and/or OR² is a phenoxy group, a naphthyloxy group, a phenoxy group which is substituted in the ortho, meta and/or para position by a C₁-C₂₀ alkyl, alkylaryl, alkoxy, phenyl, substituted phenyl, thioalkyl, nitro, halo, nitrite, carboxyalkyl, carboxyamide, —NH₂ and/or NHR⁴ group, in which R⁴ is a linear, branched or cyclic C₁-C₂₀ alkyl group, e.g. methyl, ethyl, propyl (n, iso-), butyl (n-, iso-, sec-) or phenyl,

R³ is identical or different and independently at each occurrence is represented by an alkyl, alkenyl, arylene, arylalkyl or alkylaryl having in each case 1 to 15 carbon atoms, it being possible for the radicals to contain oxygen and/or sulphur and/or nitrogen atoms, and

n is represented by 0, 1 or 2.

With more particular preference Y in formula (I) is represented by —N(C═O)—, —NR—, —NH— or —S— or organopolysiloxane, R is represented by an alkyl group or aryl group having one to 20 carbon atoms, more particularly methyl, ethyl, isopropyl, n-propyl, butyl groups (n-, iso-, sec-), cyclohexyl, phenyl and naphthyl, and OR² is identical or different and independently at each occurrence is represented by an alkoxy group, where R² is an alkyl group having 1 to 5 carbon atoms.

In one specific embodiment the organosilicon end groups are composed of end groups of the formula (I).

Surprisingly it has been found that the compositions of the invention, in comparison with the prior art, exhibit an open time which can be set across a wide range, and subsequently undergo very rapid through-cure.

The present invention accordingly provides compositions based on prepolymers P having at least two water-crosslinkable organosilicon end groups, comprising boric acid and/or boric ester and an amine component. With particular preference the composition of the invention is an adhesive or sealant or a coating. Moreover, it may alternatively comprise paints or varnishes.

Alkoxysilane groups in particular have the capacity to hydrolyse on contact with water. In this case, organosilanois (organosilicon compounds containing one or more silanol groups, SiOH groups) are formed and, by subsequent condensation reactions, organosiloxane (organosilicon compounds containing one or more siloxane groups, Si—O—-Si groups) are formed. As a result of this reaction, the composition cures. This process is also known as crosslinking. The water required for the curing reaction may either come from the air (atmospheric moisture), may be formed by the reaction of boric acid (B) with amine (C), or the composition may be contacted with a water-containing component, for example, by being brush-coated or by being sprayed, or a water-containing component may be added to the composition at the time of application, in the form, for example, of a water-containing paste, which is mixed in, for example, via a static mixer.

The organic prepolymers P of the invention with organosilicon end groups of the formula (I) are obtainable particularly by reaction of corresponding prepolymers with suitable silylating agents. Suitable silylating agents in this context are more particularly
1. Primary and/or secondary aminoalkoxysilanes; α or γ position
   e.g.

H₂N—CH₂—Si(OR²)₃

H₂N—(CH₂)₃—Si(OR²)₃

RNH—(CH₂)₃—Si(OR²)₃

RNH—CH₂—CHMe—CH2—Si(OR²)₃

where R is an alkyl group or aryl group having one to 20 carbon atoms, more particularly methyl, ethyl, isopropyl, n-propyl, butyl group (n-, iso-, sec-), cyclohexyl, phenyl and naphthyl.
2. Isocyanatoalkoxysilanes; α or γ position,
3. Products obtained by Michael addition of primary aminoalkoxysilanes in α- and γ position and ring closure to form the hydantoin, e.g. U.S. Pat. No. 5,364,955.

It also possible, however, for there to be mixtures of at least two of the stated compounds in the prepolymer P.

In one preferred embodiment, silylating agent components of interest are more particularly alkoxysilanes containing amino groups or isocyanate groups. Suitable alkoxysilanes containing amino groups are, in particular, compounds selected from the group consisting of 3-aminopropyltrimethoxysilane, 3-aminopropyltriethoxysilane, 3-aminopropylmethyldimethoxysilane, 3-aminopropylmethyldiethoxysilane, 3-amino-2-methylpropyltrimethoxysilane, 4-aminobutyltrimethoxysilane, 4-aminobutylmethyldimethoxysilane, 4-amino-3-methylbutyltrimethoxysilane, 4-amino-3,3-dimethylbutyltrimethoxysilane, 4-amino-3,3-dimethylbutyldimethoxymethylsilane, aminomethyltrimethoxysilane, aminomethyldimethoxymethylsilane, aminomethylmethoxydimethylsilane, aminomethyltriethoxysilane, aminomethyldiethoxymethylsilane, aminomethylethoxydimethylsilane, N-methyl-3-aminopropyltrimethoxysilane, N-methyl-3-aminopropyldimethoxymethylsilane, N-ethyl-3-aminopropyltrimethoxysilane, N-ethyl-3-aminopropyldimethoxymethylsilane, N-butyl-3-aminopropyltritmethoxysilane, N-butyl-3-aminopropyldimethoxymethylsilane, N-cycohexyl-3-aminopropyltrimethoxysilane, N-cyclohexylaminomethyltriethoxysilane, cyclohexylaminomethyltrimethoxysilane, N-phenyl-3-aminopropyltrimethoxysilane, N-methyl-3-amino-2-methylpropyltrimethoxysilane, N-methyl-3-amino-2-methylpropyldimethoxymethylsilane, N-ethyl-3-amino-2-methylpropyltrimethoxysilane, N-ethyl-3-amino-2-methylpropyl-dimethoxymethylsilane, N-ethyl-3-aminopropyldimethoxymethylsilane, N-ethyl-3-aminopropyltrimethoxysilane, N-phenyl-4-aminobutyltrimethoxysilane, N-phenylaminomethyldimethoxymethylsilane, N-phenylaminomethyltrimethoxysilane, N-cyclohexylaminomethyldimethoxymethylsilane, N-cyclohexylaminomethyltrimethoxysilane, N-methylaminomethyldimethoxymethylsilane, N-methylaminomethyltrimethoxysilane, N-ethylaminomethyldimethoxymethylsilane, N-ethylaminomethyltrimethoxysilane, N-propylaminomethyldimethoxymethylsilane, N-propylaminomethyltrimethoxysilane, N-butylaminomethyldimethoxymethylsilane, N-butylaminomethyltrimethoxysilane, N-(2-aminoethyl)-3-aminopropyltrimethoxysilane, N-(2-aminoethyl)-3-aminopropylmethyldimethoxysilane, 3-[2-(2-aminoethylamino) ethylamino)propyltrimethoxysilane, bis(trimethoxysilylpropyl)amine, bis(dimethoxy(methyl)silylpropyl)amine, bis(trimethoxysilylmethyl)amine, bis(dimethoxy(methyl)silylmethyl)amine, 3-ureidopropyltrimethoxysilane, N-methyl(3-trimethoxysilyl)propyl]carbamates, N-trimethoxysilylmethyl-O-methylcarbamate, N-dimethoxy(methyl)silylmethylcarbamate and the analogues thereof with ethoxy or isopropoxy groups or n-propoxy groups or n-butoxy groups or isobutoxy groups or sec-butoxy groups instead of the methoxy groups on the silicon.

Suitable alkoxysilanes containing isocyanate groups are, in particular, compounds selected from the group consisting of isocyanatoropyltriethoxysilane, isocyanatopropyltrimethoxysilane, isocyanatopropylmethyldiethoxysilane, isocyanatopropylmethyldimethoxysilane, isocyanatomethyltrimethoxysilane, isocyanatomethyltriethoxysilane, isocyanatomethylmethyldiethoxysilane, isocyanatomethylmethyldimethoxysilane, isocyanatomethyldimethylmethoxysilane or isocyanatomethyldimethylethoxysilane, and also the analogues thereof with isopropoxy or n-propoxy groups.

In one specific embodiment of the present invention, n in the formula (I) has the value 0 or 1, and so in particular trialkoxysilyl groups or dialkoxysilyl groups are present. The particular advantage of dialkoxysilyl groups is that the corresponding compositions after curing, are more elastic and softer than systems comprising trialkoxysilyl groups. They are therefore suitable especially for use as sealants. Furthermore, on curing, they give off less alcohol and therefore offer an application advantage from the standpoint of physiology as well. With trialkoxysilyl groups on the other hand, it is possible to achieve a higher degree of crosslinking, this being particularly advantageous if, after curing, a hard, solid mass is desired. Furthermore, trialkoxysilyl groups are more reactive, hence crosslink more quickly and thus reduce the amount of catalyst required, and they have advantages in terms of “cold flow”. In one particular embodiment, n therefore has a value of 0.

It is essential to the invention to use boric acid and/or boric ester in an amount of between 0.01 to 3.0% by weight, based or the total composition. The amount used in this context has a substantial influence on the open time of the system and also on the through-cure rate. Depending on the desired open time of the system according to the invention, it has been found to be preferred for there to be 0.05 to 2.0% by weight of boric acid and/or boric ester, more particularly 0.1 to 1% by weight, based on the overall composition.

In one preferred embodiment, the boric ester is at least one compound from the group consisting of boric acid tri-C1-C₆-alkyl esters, more particularly trimethyl borate, triethyl borate and/or tripropyl borate, eaters of diols, such as 2-butoxy-2-bora-1,3-dioxolane, 2-ethoxy-4,5-dimethyl-[1,3,2]-dioxaborolane, 1-aza-5-bora-4,7,13-trioxabicyclo[3.3.3]undecane, 4-methyl-2,6,7-trioxa-1-borabicyclo[2.2.2]octane, mixed boric esters of amino alcohols and diols, such as 2-(2′-aminoethoxy)-4,5-dimethyl-[1.3.2]-dioxaborolane for example, esters of acids, such as triacetyl borate, or chelates of oxalic acid or tartaric acid.

Furthermore, the choice of the amine component and of the amount thereof used in the composition of the invention has a critical influence on the open time of the system and also on the rate of through-cure. Depending on the desired open time of the system according to the invention, it has proved to be preferable for there to be 0.05% to 2.0% by weight of the amine component, more particularly 0.1% to 1% by weight, based on the overall composition. The amine component (C) may preferably be at least one amine from the group consisting of ethylamine, propoylamine, butylamine, hexylamine, octylamine, laurylamine, dibutylamine, triethylamine, cyclohexylamine, monoethanolamine, diethanolamine, diethylentriamine, 3-(dimethylamino)-1-propylamine, pentamethyldiethylentriamine, benzylamine, amino-functional silanes, more particularly 3-aminopropyltrimethoxysilane, 3-aminopropyltriethoxysilane, N-2-aminoethyl-3-aminopropyltrimethoxysilane, N-2-aminoethyl-3-aminopropyltriethoxysilane, N-(β-aminoethyl)aminopropylmethyldiethoxysilane and N-(β-aminoethyl)aminopropylmethyldimethoxysilane) and heterocyclic organic amines, more particularly N-methylpyrrolidine, N-methylpiperidine, N,N-dimethylpiperazine, diazabicyclooctane (DABCO), N-(2-hydroxyethoxyethyl)-2-azanorbornane 1,8-diazabicyclo[5.4.0]undec-7-ene (DBU), 1,5-diazabicyclo[4.3.0]non-5-ene, N-dodecyl-2-methylimidazole, N-methylimidazole, 2-ethyl-2-methylimidazole, N-methylmorpholine, bis(2-(2,6-dimethyl-4-morpholino)ethyl)-(2-(4-morpholino)ethyl)amine bis(2-(2,6-dimethyl-4-morpholino)ethyl)-(2-(2,6-diethyl-4-morpholino)ethyl)amine, tris(2-(4-morpholino)ethyl)amine, tris(2-(4-morpholino)propyl)amine, tris(2-(4-morpholino)butyl)amine, tris(2-(2,6-dimethyl-4-morpholino)ethyl)amine, tris(2-(2,6-diethyl4-morpholino)ethyl)amine, tris(2-(2-methyl-4-morpholino)ethyl)amine, tris(2-(2-ethyl-4-morpholino)ethyl)amine, dimethylaminopropylmorpholine, bis (morpholinopropyl)methylamine, diethylaminopropylmorpholine, bis(morpholinopropyl) ethylamine, bis(morpholinopropyl)propylamine, morpholinopropylpyrrolidone, N-morpholinopropyl-N-methylpiperazine, dimorpholinodiethyl ether (DMDEE) and di-2,6-dimethylmorpholinoethyl) ether, piperazines, such as N,N-dimethylpiperazine, guanidines, such as N,N,N′,N′-tetramethylguanidine, diphenylguanidine and N,N-diethyl-N′,N′-dipropyl-N″-(4-chlorophenyl)guanidine.

The amine component may be, moreover, a compound which releases an amine only in the composition of the invention, in this case it may more particularly be a latent amine. Specific examples of latent amines which can be used in accordance with the invention are ketimines, prepared from primary amines and ketones. Examples of suitable ketones include acetone, methyl ethyl ketone, methyl propyl ketone, methyl isopropyl ketone, methyl isobutyl ketone, methyl isoamyl ketone, methyl amyl ketone, diethyl ketone, dipropyl ketone, cyclohexanone. Other latent amines which can be used are aldimines, more particularly reaction products of primary amines with aldehydes, and enamines, prepared from secondary amines and aldehydes or ketones, and oxazolidines, prepared from amino alcohols and isocyanates. As amines it is possible to use the amines already described as component C.

In another embodiment, the composition of the invention comprises the amine component (C) enclosed in a matrix, the system in question being more particularly a one-component system. In this case, the amine component (C) is preferably encapsulated. In one preferred embodiment, the amine component (C) and the matrix take the form of core-shell capsules or matrix capsules. More particularly the capsules or matrix capsules have a diameter of 50 to 3000 μm, preferably 100 to 1500 μm, more particularly 200 to 1000 μm.

The matrix is preferably a swellable polymer such as polyacrylic acid, water-soluble copolymers containing sulpho groups, as described in WO 2007093392, for example or an inorganic matrix such as silica, oxides of titanium, silica gel, inorganic-organic hybrid materials, soluble salts, such as calcium chloride, alginate, carrageenan, gellan gum, amyloses and chitosan. Depending on the matrix used, the amine component (C) in the mixtures according to the invention may be released through the action of ambient moisture, shearing energy, radiation and/or changes in pH.

It may also be advantageous to use at least two amines as amine component (C), in which case one amine is preferably an adhesion promoter from the group consisting of the amino-functional silanes already specified.

Amines from the group consisting of butylamine, hexylamine, triethylamine, octylamine, laurylamine, dibutylamine, 3-(dimethylamino)-1-propylamine, diazabicyclooctane (DABCO), N-(2-hydroxyethoxyethyl)-2-azanorbornane, 1,8-diazabicyclo[5.4.0]undec-7-ene (DBU) and 1,5-diazabicyclo[4.3.0]non-5-ene have proven to be particularly suitable.

The molar ratio of boric acid and/or boric esters to the amine component may be varied freely within wide ranges. It is advantageous if the ratio is from 1:0.003 to 1:300, especially 10:0.05 to 1:20 and very preferably 1:0.1 to 1:10.

Through an appropriate choice of the ratio of amine to boric ester and/or boric acid and the amount used, relative to the overall composition, it is possible to adjust the open time within wide limits. More particularly this time is between 0.5 minutes and 3 days, preferably 5 minutes to 10 hours, and with particular preference from 10 minutes to 1 hour.

One particular advantage of the system according to the invention is the subsequently rapid through-cure. The through-cure rate was measured as described in the examples. The rate of through-cure can be varied within wide ranges and is dependent on the nature and amount of the boric acid component and the amine component. It is possible to achieve average through-cure rates for 10 mm of less than 2 days.

The organic prepolymer P may preferably be at least one polymer compound based on acrylates, polyurethanes, polyureas, polyethers and polyesters. The prepolymers may also contain polyorganosiloxane blocks which are incorporated, for example, through hydrosilylation of H-terminated polyorganosiloxanes with polymer building blocks which carry vinyl groups. Furthermore, the polyorganosiloxanes may contain reactive groups via which the polyorganosiloxane is incorporated covalantly into the organic prepolymer P. Preferred reactive groups here are primary and secondary amino groups, hydroxyl groups, carboxyl groups and epoxy groups, trialkoxysilanes, and (meth)acrylate groups.

Where the parent structure of the organic prepolymers P comprises polyurethanes and polyureas, these structures are composed of at least one polyol and/or polyamine component and also a polyisocyanate component, and may optionally include a chain extender.

The mode of preparation of the polyurethane or polyurea prepolymers is not critical to the present invention. It may, therefore, be a one-stage operation in which the polyols and/or polyamines, polyisocyanates and chain extenders are reacted simultaneously with one another, as may take place, for example, in a batch reaction, or it may be a two-stage operation, in which, for example, first a prepolymer is formed, and is subsequently reacted with chain extenders.

The polyurethanes or polyureas may also additionally comprise other structural units, which more particularly may be allophanates, biuret, uretdione or cyanurates. The aforementioned groups, however, are only examples, and the polyurethanes and polyureas of the invention may also include other structural units. The degree of branching as well is not critical to the present invention, and so both linear and highly-branched polymers can be used.

In one preferred embodiment of the invention, the molar ratio of the isocyanate component present in the polymer to the sum of the polyol and/or polyamine component is 0.01 to 50, preferably 0.5 to 1.8.

The isocyanate component is preferably an aliphatic, cycloaliphatic, araliphatic and/or aromatic compound, preferably a diisocyanate or triisocyanate, and mixtures of these compounds may also be involved. In this context it is considered preferred for this compound to be hexamethylene 1,6-diisocyanate (HDI), HDI dimer, HDI trimer, 1-isocyanato-3,3,5-trimethyl-5-isocyanatomethylcyclohexane (IPDI), 2,4- and/or 2,6-tolylene diisocyanate (TDI) and/or 4,4′-, 2,4′- and/or 2,2′-diphenylmethane diisocyanate (MDI) polymeric MDI, carbodiimide-modified 4,4′-HDI, m-xylylene diisocyanate (MXDI), m- or p-tetramethylxylylene diisocyanate (m-TMXDI, p-TMXDI), 4,4′-dicyclohexylmethane diisocyanate (H12MDI), naphthalene 1,5-diisocyanate, cyclohexane 1,4-diisocyanate, hydrogenated xylylene diisocyanate (H6XDI), 1-methyl-2,4-diisocyanatocyclohexane, tetramethoxybutane 1,4-diisocyanate, butane 1,4-diisocyanate, 1,6-diisocyanato-2,2,4-trimethylhexane, 1,6-diisocyanato-2,4,4-trimethylhexane, 1-isocyanato-1-methyl-4(3)-isocyanatomethylcyclohexane (IMCI) and 1,12-dodecane diisocyanate (C12DI). It may additionally be 4-dichlorophenyl diisocyanate, dicyclohexylmethane 4,4′-diisocyanate, m-phenylene diisocyanate, p-phenylene diisocyanate, 4-chloro-1,3-phenylene diisocyanate, 1,6-hexamethylene diisocyanate, 1,10-decamethylene diisocyanate, lysine alkyl ester diisocyanate, 3,3′-dimethyl-4,4′-diphenylmethane diisocyanate, xylylene diisocyanate, tetramethylxylylene diisocyanate, 1,5-tetrahydronaphthalene diisocyanate, triisocyanatotoluene, methylenebis(cyclohexyl) 2,4′-diisocyanate and 4-methylcyclohexane 1,3-diisocyanate. Particularly suitable are polyisocyanates having two or three isocyanate groups per molecule. Alternatively, mixtures of polyisocyanates may be involved, in which case the average number of isocyanate groups in the mixture may more particularly be 2.1 to 2.3. 2.2 to 2.4 or 2.6 to 2.8. Derivatized polyisocyanates may likewise be used, examples being sulphonated isocyanates, blocked isocyanates, isocyanurates and biuret isocyanates.

The polyol and/or polyamine component may preferably be polyetheresterpolyol, polyetherpolyols, polyesterpolyols, polybutadienepolyols and plycarbonatepolyols, and may also be mixtures of these compounds. The polyols and/or polyamines comprise preferably between two and 10, more preferably between two and three hydroxyl groups and/or amino groups, and possess a weight-average molecular weight of between 32 and 30 000, more preferably between 90 and 18 000 g/mol. Suitable polyols are preferably the polyhydroxy compounds which at room temperature are liquid, glass-like solid/amorphous or crystalline. Typical examples include difunctional polypropylene glycols. Use may also be made preferably of hydroxyl-containing random copolymers and/or block copolymers of ethylene oxide and propylene oxide. Suitable polyether polyols are the polyethers known per se in polyurethane chemistry, such as the polyols prepared by means of KOH or DMC catalysis, using starter molecules, from styrene oxide, ethylene oxide, propylene oxide, butylene oxide, tetrahydrofuran or epichlorohydrin.

Also suitable specifically and in particular are poly(oxytetramethylene) glycol (polyTHF), 1,2-polybutylene glycol, or mixtures thereof. Especially suitable are polypropylene oxide, polyethylene oxide and butylene oxide and mixtures thereof. Another type of copolymer which can be used as a polyol component and has hydroxyl groups terminally is represented by the general formula below (preparable, for example, by means of “controlled” high-speed anionic polymerization in accordance with Macromolecules 2004, 37, 4038-4043):

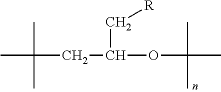

in which R is identical or different and is represented preferably by OMe, OiPr, Cl or Br.

Additionally suitable as a polyol component are, is particular, the polyester diols and polyester polyols which at 25° C. are liquid, glass-like amorphous or crystalline and are preparable by condensation of dicarboxylic or tricarboxylic acids, such as adipic acid, sebacic acid, glutaric acid, azelaic acid, suberic acid, undecanedioic acid, dodecanedioic acid, 3,3-dimethylglutaric acid, terephthalic acid, isophthalic acid, hexahydrophthalic acid and/or dimer fatty acid, with low molecular mass diols, triols or polyols, such as ethylene glycol, propylene glycol, diethylene glycol, triethylene glycol, dipropylene glycol, 1,4-butanediol, 1,6-hexanediol, 1,8-octanediol, 1,10-decanediol, 1,12-dodecanediol, dimer fatty alcohol, glycerol, pentaerythritol and/or trimethylolpropane.

A further suitable group of polyols are the polyesters based, for example, on caprolactone, also referred to as “polycaprolactones”. Other polyols which can be used are polycarbonate-polyols and dimer-diols and also polyols based on vegetable oils and their derivatives, such as castor oil and its derivatives or epoxidized soybean oil.

Also contemplated are hydroxyl-containing polycarbonates, which are obtainable by reacting carbonic acid derivatives, such as diphenyl carbonate, dimethyl carbonate or phosgene, with diols. Particular suitability is possessed by, for example, ethylene glycol, 1,2- and 1,3-propanediol, 1,3- and 1,4-butenediol, 1,6-hexanediol, 1,8-octanediol, neopentylglycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenol A, tetrabromobisphenol A, glycerol, trimethylolpropane, 1,2,6-hexanetriol, 1,2,4-butanetriol, trimethylolpropane, pentaerythritol, mannitol, sorbital, methylglycoside and 1,3,4,6-dianhydrohexitols. The hydroxyl-functional polybutadienes as well which can be purchased under the trade name “Poly-bd®” may serve as a polyol component, as may their hydrogenated analogues. Additionally contemplated are hydroxy-functional polysulphides which are sold under the trade name “Thiokol®NPS-282”, and also hydroxy-functional polysiloxanes.

Particularly suitable as a polyamine component which can be used in accordance with the invention are hydrazine, hydrazine hydrate, and substituted hydrazines, such as N-methylhydrazine, N,N′-dimethylhydrazine, acid hydrazides of adipic acid, methyladipic acid, sebacic acid, hydracrylic acid and terephthalic acid, semicarbazidoalkylene hydrazides, such as 13-semicarbazidopropionioc hydrazide, semicarbazidoalkylene-carbazine esters, such as 2-semicarbazidoethyl-carbazine ester for example, and/or aminosemicarbazide compounds, such as 13-aminoethyl semicarbazidocarbonate. Additionally suitable for preparing the polyurethanes and polyureas are polyamines based on polyesters, polyolefins, polyacetals, polythioethers, polyethercarbonates, polyethylene terephthalates, polyesteramides, polycaprolactams, polycarbonates, polycaprolactones, and polyacrylates which contain at least two amine groups. Polyamines, examples being those sold under the trade name Jeffamine® (which are polyetherpolyamines), are also suitable.

Also contemplated as a polyol component and/or polyamine component are the species known as what are called chain extenders, which in the preparation of polyurethanes and polyureas react with excess isocyanate groups, normally have a molecular weight (Mn) of below 400, and frequently take the form of polyols, aminopolyols or aliphatic, cycloaliphatic or araliphatic polyamines.

Examples of suitable chain extenders include the following compounds:
alkanediols, such as ethanediol, 1,2- and 1,3-propanediol, 1,4- and 2,3-butanediol, 1,5-pentanediol, 1,3-dimethylpropanediol, 1,6-hexanediol, neopentylglycol, cyclohexanedimethanol, 2-methyl-1,3-propanediol, hexylene glycol, 2,5-dimethyl-2,5-hexanediol, ethylene glycol, 1,2- or 1,3-propanediol, 1,2-, 1,3- or 1,4-butanediol, 1,2-, 1,3-, 1,4- or 1,5-pentanediol, 1,2-, 1,3-, 1,4-, 1,5- or 1,6-hexanediol, neopentyl hydroxypivalate, neopentylglycol, dipropylene glycol, diethylene glycol, 1,2-, 1,3- or 1,4-cyclohexanediol, 1,2-, 1,3- or 1,4-cyclohexanedimethanol, trimethylpentanediol, ethylbutylpropanediol, diethyloctanediols, 2-butyl-2-ethyl-1,3-propanediol, 2-butyl-2-methyl-1,3-propanediol, 2-phenyl-2-methyl-1,3-propanediol, 2-propyl-2-ethyl-1,3-propanediol, 2-di-tert-butyl-1,3-propanediol, 2-butyl-2-propyl-1,3-propanediol, 1-dihydroxymethylbicyclo[2.2.1]heptane, 2,2-diethyl-1,3-propanediol, 2,2-dipropyl-1,3-propanediol, 2-cyclohexyl-2-methyl-1,3-propanediol, 2,5-dimethyl-2,5-hexanediol, 2,5-diethyl-2,5-hexanediol, 2-ethyl-5-methyl-2,5-hexanediol, 2,4-dimethyl-2,4-pentanediol, 2,3-dimethyl-2,3-butanediol, 1,4-bis(2′-hydroxypropyl)benzene, and 1,3-bis(2′-hydroxypropyl)benzene and
δ-hydroxybutyl-ε-hydroxycaproic esters, ω-hydroxyhexyl-γ-hydroxy-butyric esters, β-hydroxyethyl adipate or bis(β-hydroxyethyl)terephthalate, and
aliphatic diamines, aromatic diamines and alicyclic diamines, more particularly methylenediamine, ethylenediamine, 1,2- and 1,3-diaminopropane, 1,4-diaminobutane, cadaverine (1,5-diaminopentane), 1,6-hexamethylenediamine, isophoronediamine, piperazine, 1,4-cyclohexyldimethylamine, 4,4′-diaminodicyclohexylmethane, aminoethylethanolamine, 2,2,4-trimethylhexamethylenediamine, 2,4,4-trimethylhexamethylenediamine, Octamethylenediamine, m- or p-phenylenediamine, 1,3- or 1,4-xylylenediamine, hydrogenated xylylenediamine, bis(4-aminocyclohexyl)methane, 4,4′-methylenebis(ortho-chloroaniline), di(methylthio)toluenediamine, diethyltoluenediamine, N,N′-dibutylaminodiphenylmethane, bis(4-amino-3-methylcyclohexyl)methane, isomer mixtures of 2,2,4- and 2,4,4-trimethylhexamethylenediamine, 2-methylpentamethylenediamine, diethylenetriamine, and 4,4-diaminodicyclohexylmethane, and also
ethanolamine, hydrazine ethanol, 2-[(2-aminoethyl)amino]ethanol.

Finally, it is noted that the polyol component and or polyamine component may contain double bonds which may result, for example, from long-chain aliphatic carboxylic acids or fatty alcohols. Functionalization with olefinic double bonds is also possible, for example, through the incorporation of vinylic or allylic groups. These groups may originate, for example, from unsaturated acids such as maleic anhydride, acrylic acid or methacrylic acid, and their respective esters.

For the purposes of the invention it is preferred for the polyol component and/or polyamine component to comprise polypropylenediol, polypropylenetriol, polypropylenepolyol, polyethylenediol, polyethylenetriol, polyethylenepolyol, polypropylenediamine, polypropylenetriamine, polypropylenepolyamine, polyTHF-diamine, polybutadienediol, polyesterdiol, polyestertriol, polyesterpolyol, polyesteretherdiol, polyesterethertriol, polyesteretherpolyol, more preferably polypropylenediol, polypropylenetriol, polyTHF-diol, polyhexanediol carbamate-diol, polycaprolactamdiol and polycaprolactamtriol. Mixtures of the stated compounds, furthermore, may also be involved.

In one particularly preferred embodiment, the polyurethanes or polyureas comprise polyols having a molecular weight of between 1000 and 18 000, more particularly 2000 to 12 000 and very preferably 3000 to 9000 g/mol. These polyols are with particular preference Poly-THF-diol, polypropylene glycol and also random copolymers and/or block copolymers of ethylene oxide and propylene oxide. Having proven to be preferred in this context are the polyetherpolyols prepared by KOH catalysis. In one preferred embodiment, chain extenders used are diols have a molecular weight of 60 to 500, more particularly 85 to 200, with the dioligomers of glycols being particularly preferred. With regard to the properties of these compositions of the invention it is particularly advantageous furthermore, if the polyurethanes or polyureas comprise 2,4- and/or 2,6-tolylene diisocyanate (TDI) and/or 4,4′-, 2,4′- and/or 2,2′-diphenylmethane diisocyanate (MDI), especially isomer mixtures of TDI, where a 2,4-isomer fraction of more than 40% is particularly preferred.

The polyurethanes or polyureas may also comprise crosslinker components, chain stopper components and other reactive components. Some crosslinkers have already been listed among the chain extenders having at least three reactive hydrogens. In particular they may be glycerol, tetra(2-hydroxypropyl)ethylenediamines, pentaerythritol, trimethylolpropene, sorbitol, sucrose, triethanolamine and polymers having at least three reactive hydrogens (e.g. polyetheramines having at least three amine groups, polymeric triols etc.). Chain stoppers contemplated include, in particular, compounds having reactive hydrogens such as monools, monoamines, monothiols and monocarboxylic acids. One specific embodiment uses monools—C₁- to C₁₂ alcohols (especially methanol to dodecyl alcohol), higher alcohols, polymers such as, for instance, polyethers and polyesters having an OH group and structural units such as glycerol or sucrose, in which all bar one OH group have been reacted, with no other reactive hydrogens being introduced during the reaction.

In one particularly UV-resistant variant, it is preferred as a polyol component to use polyesters having at least two OH groups, polycarbonates having at least two OH groups, polycarbonate esters having at least two OH groups, PolyTHF, polypropylene glycol, random copolymers and/or block copolymers of ethylene oxide and propylene oxide.

Compositions of the invention comprising polyurethanes may further comprise light stabilizers, especially of the Hals type. An example is 4-amino-2,2,6,6-tetramethylpiperidine.

Where the parent structure of the organic prepolymer P comprises acrylates, by these are meant compounds which include at least one monomer of the series of the acrylic esters and methacrylic esters, with preferably at least 70% by weight of the polymer being composed of at least one compound from the series of acrylic esters, methacrylic esters and styrenes.

The monomers of the acrylate component are preferably at least one compound from the series of ethyldiglycol acrylate, 4-tert-butylcyclohexyl acrylate, dihydrocyclopentadienyl acrylate, lauryl (meth)acrylate, phenoxyethyl acrylate, isobornyl (meth)acrylate, dimethylaminoethyl methacrylate, cyanoacrylates, citraconate, itaconate and derivatives thereof, (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-propylheptyl acrylate, 2-ethylhexyl (meth)acrylate, nonyl (meth)acrylate, decyl (meth)acrylate, isodecyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylates, γ-(methacryloyloxypropyl)trimethoxysilane, ethylene oxide adducts of (meth)acrylic acid, trifluoromethylmethyl (meth)acrylate, 2-trifluoromethyethyl (meth)acrylate, 2-perfluoroethylethyl (meth)acrylate, 2-perfluoroethyl-2-perfluorobutylethyl (meth)acrylate, 2-perfluoromethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate and 2-perfluorohexadecylethyl (meth)acrylate.

In one particular embodiment, two or more monomers are from the series of n-butyl acrylate, 2-hydroxyethyl (meth)acrylate, acrylic acid, methacrylic acid and methyl methacrylate.

In another embodiment, copolymers of at least two of the aforementioned monomers are used, the proportion being selected such that the copolymers obtained have the desired performance properties for the respective end use. The skilled person is aware of suitable copolymers having the desired performance properties. For adhesives and sealants, more particularly, preference is given to copolymers of n-butyl acrylate and methyl methacrylate which are used in a molar ratio in which the resultant copolymer possesses a glass transition temperature which lies between those of the corresponding homopolymers. All in all, the acrylates of the present invention may be copolymers or homopolymers.

The acrylic acid polymers, may further comprise other ethylenically unsaturated monomers as well. Examples here include monounsaturated and polyunsaturated hydrocarbon monomers, vinyl esters (e.g. vinyl esters of C₁ to C₆ saturated monocarboxylic acids), vinyl ethers, monoethylenically unsaturated monocarboxylic and polycarboxylic acids and alkyl esters of these monocarboxylic and polycarboxylic acids (e.g. acrylic esters and methacrylic esters such as, for instance, C₁ to C₁₂ alkyl and more particularly C₁ to C₄ alkyl esters), amino monomers and nitriles, vinyl- and alkylvinylidenes and amides of unsaturated carboxylic acids. Additionally contemplated are unsaturated hydrocarbon monomers comprising styrene compounds (e.g. styrene, carboxylated styrene and alpha-methylstyrene), ethylene, propylene, butylene and conjugated dienes (butadiene, isoprene and copolymers of butadiene and isoprene). As far as the vinyl- and halovinylidene monomers are concerned mention may be made of vinyl chloride, vinylidene chloride, vinyl fluoride and vinylidene fluoride. Examples of the vinyl esters include aliphatic vinyl esters, such as for instance, vinyl formate, vinyl acetate, vinyl propionate, vinyl butyrate, vinyl isobutyrate, vinyl valerate, vinyl caproate and allyl esters of the saturated monocarboxylic acids, such as allyl acetate, allyl propionate and allyl lactate. As far as the vinyl ethers are concerned, mention may be made of methyl vinyl ether, ethyl vinyl ether and n-butyl vinyl ether. Typical vinyl ketones include methyl vinyl ketone, ethyl vinyl ketone and isobutyl vinyl ketone. Examples of the dialkyl esters of monoethylenically unsaturated dicarboxylic acids are dimethyl maleate, diethyl maleate, dibutyl maleate, dioctyl maleate, diisooctyl maleate, dinonyl maleate, diisodecyl maleate, ditridecyl maleate, dimethyl fumarate, diethyl fumarate, dipropyl fumarate, dibutyl fumerate, dioctyl fumarate, diisooctyl fumarate, didecyl fumarate, dimethyl itaconate, diethyl itaconate, dibutyl itaconate and dioctyl itaconate. In particular, the monoethylenically unsaturated monocarboxylic acids in question are acrylic acid, methacrylic acid, ethacrylic acid and crotonic acid. With regard to the monoethylenically unsaturated dicarboxylic acids, mention may be made of maleic acid, fumaric acid, itaconic acid and citric acid. As monoethylenically unsaturated tricarboxylic acids it is possible, with regard to the present invention, to make use, for example of aconitic acid and the halogen-substituted derivatives thereof. Furthermore, the anhydrides and esters of the aforementioned acids may be used (for example maleic anhydride and citric anhydride). Examples of nitriles of ethylenically unsaturated monocarboxylic, dicarboxylic, and tricarboxylic acids include acrylonitrile, α-chloroacrylonitrile and methacrylonitrile. The amides of the carboxylic acids may be acrylamides, methacrylamides and other α-substituted acrylamides and N-substituted amides e.g. N-methylolacrylamide, N-methylolmethylacrylamide, alkylated N-methylolacrylamides and N-methylolmethacrylamides (e.g. N-methoxymethylacrylamide and N-methoxymethylmethacrylamide). As amino monomers use may be made of substituted and unsubstituted aminoalkyacrylates, hydrochloride salts of the amino monomers and methacrylates such as, for instance, β-aminoethyl acrylate, β-aminoethyl methacrylate, dimethylaminomethyl acrylate, β-methylaminoethyl acrylate and dimethylaminomethyl methacrylate. With regard to the cationic monomers, mention may be made in the context of the present invention, of α- and β-ethylenically unsaturated compounds which are suitable for the polymerization and contain primary, secondary or tertiary amino groups, examples being dimethylaminoethyl methacrylate, dimethylaminoneopentyl acrylate, dimethylaminopropyl methacrylate and tert-butylaminoethyl methacrylate or organic and inorganic salts of these compounds and/or alkylammonium compounds such as, for instance, trimethylammonioethyl methacrylate chloride, diallyldimethylammonium chloride, β-acetamidodiethylaminoethyl acrylate chloride and methaacrylamidopropyltrimethylammonium chloride. These cationic monomers may be used alone or in combination with the aforementioned other monomers. Examples of hydroxy-containing monomers further include the β-hydroxyethyl acrylates, β-hydroxypropyl acrylates, γ-hydroxypropyl acrylates and β-hydroxyethyl methacrylates.

The polymers P which can be used in accordance with the invention and are based on acrylates are synthesized from at least one acrylate component and at least two organosilicon end groups. The acrylates may be obtained, for example, from the reaction of alkenyl-terminated acrylates hydrosilylation, in which case the alkenyl-terminated acrylates may be prepared via Atom Transfer Radical Polymerization (ATRP) or from the reaction of alkenyl-terminated acrylates with monomer-containing organosilicon end groups, in which case the alkenyl-terminated acrylates may be prepared via Atom Transfer Radical polymerization (ATRP). Other controlled radical polymerizations as well, such as NMP (Nitroxide Mediated Polymerization), SET (Single Electron Transfer polymerization) or RAFT (Reversible Addition Fragmentation chain Transfer polymerization) are also suitable.

Where the organosilicon end groups are attached to the acrylate component by hydrosilylation, suitability is possessed by alkoxysilane compounds, more particularly trimethoxysilane, triethoxysilane, methyldiethoxysilane, methyldimethoxysilane and phenyldimethoxysilane.

Where the organosilicon end groups are attached to the acrylate component through a monomer, suitable monomers include more particularly 3-(meth)acryloyloxypropyltrimethoxysilane, 3-(meth)acryloyloxypropylmethyldimethoxysilane, 3-(meth)acryloyloxypropyltriethoxysilane, 3-(meth)acryloyloxypropylmethyldiethoxysilane, (meth)acryloyloxymehtyltrimethoxysilane, (meth)acryloyloxymethylmethyldimethoxysilane, (meth)acryloyloxymethyltriethoxysilane and (meth)acryloyloxymethylmethyldiethoxysilane.

The organic prepolymers P of the invention, based on acrylates and with organosilicon end groups, possess preferably a weight-average molecular weight between 500 and 200 000 g/mol, more preferably between 5000 and 100 000 g/mol.

The parent structure of the organic prepolymers P may also comprise polyethers. For some time, for example, there have been construction sealants on the market which comprise what is called MS-Polymer® from Kaneka Corp. and/or Excestar from Asahi Glass Chemical Corp., where “MS” stands for “modified silicone”. These alkoxysilane-terminated polyethers are especially suitable for the present invention. They are polymers which consist of polyether chains having alkoxysilane end groups, prepared by the hydrosilylation of terminal double bonds. The alkoxysilane end groups are composed of a silicon which is attached to the polyether chain and to which two alkoxy groups and one alkyl group or three alkoxy groups, are attached.

Suitable polyether components include the polyols prepared, using starter molecules from styrene oxide, propylene oxide, butylene oxide, tetrahydrofuran or epichlorohydrin. Particularly suitable are polypropylene oxide, polybutylene oxide, polyethylene oxide and tetrahydrofuran, or mixtures thereof. In this context, molecular weights of between 500 and 100 000 g/mol, especially 3000 and 20 000 g/mol, are preferred in particular.

For the introduction of double bonds, the polyether is reacted with organic compounds comprising a halogen atom selected from the group consisting of chlorine, bromine and iodine, and also comprising a terminal double bond. Particularly suitable for this purpose are allyl chlorides, allyl bromide, vinyl(chloromethyl)benzene, allyl(chloromethyl)benzene, allyl(bromomethyl)benzene, allyl chloromethyl ether, allyl(chloromethoxy)benzene, butenyl chloromethyl ether, 1,6-vinyl(chloromethoxy)benzene, where allyl chloride in particular is preferably used.

The resulting polyethers with terminal double bonds are reacted by hydrosilylation to form polyethers having alkoxysilane end groups. Suitable hydrosilylating agents in this context include more particularly trimethoxysilane, triethoxysilane, methyldiethoxysilane, methyldimethoxysilane and phenyldimethoxysilane.

Besides the components (A), (B) and (C) the composition of the invention may comprise additional, further components depending on intended use. More particularly, these components include at least one further ingredient from the series consisting of auxiliaries and additives, dispersants, film-forming assistants, pigments, rheological assistants, water scavengers, adhesion promoters, catalysts, plasticizers, light stabilizers, ageing inhibitors, flame retardants and/or biocides.

These may, more particularly, be the following components:
adhesion promoters, e.g. epoxysilanes, anhydridosilanes, adducts of silanes with primary aminosilanes, ureidosilanes, aminosilanes, diaminosilanes, and their analogues as monomer or oligomer and urea-silanes; e.g. Dynasylan AMEO, Dynasylan AMMO, Dynasylan DAMO-T, Dynasylan 1146, Dynasylan 1189, Silquest A-Link 15, epoxy resins, alkyl titanates, titanium chelates, aromatic polyisocyanates, phenolic resins;
water scavengers, vinyltriethoxysilane, vinyltrimethoxysilane, α-functional silanes such as N-(silylmethyl)-O-methylcarbamates, especially N-(methyldimethoxysilylmethyl)-O-methylcarbamate, (methacryloyloxymethyl)silanes, methoxymethylsilanes, N-phenylsilanes, N-cyclohexylsilanes and N-alkylsilanes, orthoformic esters, calcium oxide or molecular sieve;
catalysts such as organobismuth compounds or bismuth complexes. Further metal catalysts contemplated include titanium, zirconium, zinc, Sn, and lithium catalysts and also metal carboxylates, and combinations of different metal catalysts may also be used;
light stabilizers and ageing inhibitors, which act in particular as stabilizers against heat, light and UV radiation, examples being phenolic antioxidants which act as free-radical scavengers, such as 2,6-di-tert-butyl-p-cresol, 2,6-di-tert-butylphenol, 2,4-dimethyl-6-tert-butylphenol, 2,2′-methylenebis(4-methyl-6-tert-butylphenol), 4,4′-butylidenebis(3-methyl-6-tert-butylphenol), 4,4′-thiobis(3-methyl-6-tert-bulylphenol), 5-tetrakis[methylene-3-(3,5-di-tert-butyl4-hydroxyphenyl)propionate]methanes and 1,1,3-tris(2-methyl-4-hydroxy-5-tert-butylphenyl)butanes and antioxidants based on amines (for example phenyl-β-naphthylamine, α-naphthylamine, N,N′-di-sec-butyl-p-phenylenediamine, phenothiazine and N,N′-diphenyl-p-phenylenediamines);
flame retardants;

biocides, such as algicides, or fungal growth inhibitors;
fillers, examples being ground or precipitated calcium carbonates, coated if desired with fatty acids and/or fatty acid mixtures, examples being stearates, more particularly finely-divided coated calcium carbonate, carbon blacks, especially industrially manufactured carbon blacks, kaolins, aluminium oxides, silicas, especially highly dispersed silica from pyrolysis operations, PVC powders or hollow beads. Preferred fillers are carbon black, calcium carbonates, such as precipitated or natural chalk products such as Omyacarb® from Omya, Ultra P-Flex® from Specialty Minerals Inc, Socal® U1S2, Socal® 312, Winnofil® 312 from Solvay, Hakuenka® from Shiraishi, highly dispersed silicas from pyrolysis operations and also combinations of these fillers. Likewise suitable are minerals such as siliceous earth, talc, calcium sulphate (gypsum) in the form of anhydrite, hemihydrate or dihydrate, finely ground quartz, silica gel, precipitated or natural barium sulphate, titanium dioxide, zeolites, leucite, potash feldspar, biotide, the group of the soro-, cyclo-, ino-, phyllo- and hectosilicates, the group of the low-solubility sulphates such as gypsum, anhydrite or heavy spar, and also calcium minerals such as calcite, metals in powder form (for example aluminium, zinc or iron) and barium sulphate;
rheology modifiers, such as, for example, thickeners, e.g. urea compounds, polyamide waxes, bentonites, silicones, polysiloxanes, hydrogenated castor oil, metal soaps, such as calcium stearate, aluminium stearate, barium stearate, fumed silica and also poly(oxy-1,2-ethanediyl)-α-hydro-Ω-hydroxy polymer with oxy-1,2-ethanediyl-α-hydro-Ω-hydroxy-nonyl-phenoxyglycidyl ether oligomers and 5-isocyanato-1-(isocyanatomethyl)-1,3,3-trimethylcyclohexane or hydroxyethylcellulose or polyacrylic acid polymers and copolymers;
surface-active substances such as, for example, wetting agents, flow control agents, devolatilizing agents, defoamers and dispersants;
fibres, for example of carbon, cellulose, polyethylene or propylene;
pigments, e.g., titanium dioxide;
solvents such as, for instance water, aromatic hydrocarbons such as toluene and xylene, solvents based on esters such as ethyl acetate, butyl acetate, allyl acetate and cellulose acetate and solvents based on ketones such as methyl ethyl ketone, methyl isobutyl ketone and diisobutyl ketone and also acetone, alcohols such as, for example, isononyl alcohol and mixtures of at least two of the aforementioned solvents,
   and also further substances suitable for the particular end use, particular in the field of adhesives and sealants and also coatings.

Where the compositions of the invention are adhesives and sealants or coatings, they may comprise plasticizers. Such plasticizers are disclosed in, for example, WO 2008/027463 on page 19, line 5 to page 20, line 9. WO 2008/027463 is hereby incorporated by reference and the content thereof is incorporated in the application.

The compositions of the invention cure on contact with water. Curing takes place in each case with different rates depending on temperature, nature of contact, amount of moisture and weight fraction of components (B) and (C) and, where used, of further catalysts. In the case of curing by means of atmospheric moisture, a skin is first formed on the surface of the composition. The so-called skin-forming time, accordingly, represents a measure of the cure rate. A skin-forming time of this kind of up to 3 hours at 23° C. and 50% relative humidity is typically worth aiming for. For specific applications, however, a longer skin-forming time may also be advantageous.

In one particular embodiment, in which boric esters (B) are used, the composition of the invention is a one-component system. One aspect of the present invention, accordingly, is a method for the curing of a composition of the invention where (B) comprises boric esters, the composition takes the form of a one-component system and the composition is exposed to ambient moisture.

It is advantageous to ensure that the components used in a one-component system do not detract from the shelf life or storage stability of the composition, in other words that the components used do not trigger, to any significant extent, the reaction—leading to crosslinking—of the organosilicon end groups present in the composition, in the course of storage. In particular, this means that such further components contain preferably no water or at most traces of water. It may therefore be sensible to carry out chemical or physical drying of certain components before incorporating them into these compositions. If this is not possible or not desirable, it may in these cases be advantageous to configure the composition in the form of a two-component system, with the component or components that adversely affect the shelf life being formulated separately from the organic polymer (A) in the second component.

A two-component system is of advantage in particular when (B) comprises boric acid, in which case amine (C) can be formulated separately from boric acid (B). In this case, one component of the two-component system may preferably comprise the organic prepolymer P (A) and amine (C), while the second component comprises boric acid (B). It is also possible, however, for one component of the two-component systems to comprise the organic prepolymer P (A) and boric acid (B), while the second component comprises amine (C). Where the composition comprises further constituents which adversely affect the shelf life, these constituents may likewise be formulated separately from organic prepolymer P (A) in the second component.

One aspect of the present invention is therefore a method for the curing of a composition of the invention where (B) comprises boric acid which is present separately from the amine component (C) in a two-component system and the components are mixed with one another.

The use of boric acid (B) has the advantage that the curing can be carried out in the absence of ambient moisture. Water in this case is released through the reaction of the boric acid (B) with amine (C). In this way it is possible to cure the composition in the form of relatively thick coats or structures which have an inner region which is at a relatively large distance from the surface of the structure. In the case of curing by ambient moisture, the curing of such structures is difficult, since the moisture has to diffuse over a relatively long path through the structure. As soon as the outer region has cured right through, further diffusion into the interior of the structure may be severely retarded, meaning that the through-curing of the system takes up a long time. After homogeneous mixing of the two-component system of the invention, in contrast, water is released uniformly throughout the system through the reaction of boric acid (B) and amine (C). The through-curing of the system is therefore independent of the structure that is formed with the composition. One aspect of the present invention is therefore a method for the curing of a composition of the invention where the curing is carried out in the absence of ambient moisture.

In one preferred embodiment the composition of the invention comprises boric acid (B), which is included in a matrix, the system in question more particularly being a one-component system. The boric acid in this case is preferably in encapsulated form. In one preferred embodiment the boric acid and the matrix are present in the form of a core-shell capsule or matrix capsule. The capsule or matrix capsule more particularly has a diameter of 50 to 3000 μm, preferably 100 to 1500 μm, more particularly 200-1000 μm.

The matrix preferably a swellable polymer such as polyacrylic acid, water-soluble copolymers containing sulfo groups, as described in WO 2007093392, for example, or an inorganic matrix such as silica, titanium oxides, silica gel, inorganic/organic hybrid materials, soluble salts, such as calcium chloride, alginate, carrageenan, gellan gum, amyloses and chitosan. Depending on the matrix used, the boric acid may be released in the mixtures of the invention through the action of ambient moisture, shearing energy, radiation and/or changes in pH.

A further aspect of the present invention is therefore a method for the curing of a composition of the invention where (B) comprises boric acid which is enclosed in a matrix, the composition is in the form of a one-component system and the composition is exposed to ambient moisture.

Another embodiment of the present invention is a method for the curing of a composition of the invention where the amine component (C) is enclosed in a matrix, the composition is in the form of a one-component system, and the composition is subjected to conditions under which the amine component (C) is released from the matrix.

A further aspect is a method for the curing of a composition of the invention where the amine component (C) is a latent amine, the composition is in the form of a one-component system, and the composition is subjected to conditions under which the amine is released.

The compositions of the invention in the form of one- or two-component systems may be stored in the absence of moisture in suitable packaging or a suitable facility such as, for example, a drum, a pouch or a cartridge over a period from several months through to a number of years without undergoing alteration in their application properties or in their properties after curing to any extent that is relevant for service. Typically the shelf life is determined by measuring the viscosity, the extrusion quantity or the extrusion force.

In the cured state, the compositions of the invention possess high mechanical strength in tandem with high stretchability and also good adhesion properties. By virtue of these properties they are suitable for a multiplicity of applications, more particularly as an elastic adhesive, as an elastic sealant or as an elastic coating. They are suitable more particularly for applications which require rapid curing and impose exacting requirements in terms of stretchability, in conjunction with exacting requirements with regard to adhesive quality and strength.

A further subject of the present invention is therefore the use of the composition as an adhesive or sealant for producing fusional bonds between adherends. In the cured state the composition of the invention possesses high mechanical strength in tandem with high stretchability and also good adhesion properties. By virtue of these properties it is suitable for a multiplicity of applications, more particularly as an elastic adhesive, as an elastic sealant or as an elastic coating. It is suitable more particularly for applications which require a long open time and rapid curing and impose exacting requirements in terms of stretchability, in conjunction with exacting requirements concerning the adhesion properties and the strengths.

Suitable applications are, for example, the fusional bonds between adherends of concrete, mortar, glass, metal, ceramic, plastic and/or wood. In one particular embodiment the adherends are first a surface and second a carpet, a PVC covering, a laminate, a rubber covering, a cork covering, a linoleum covering, a wood covering, e.g. wood flooring, boards, decking or tiles. The composition of the invention may, in particular, be used for grouting natural stone. Furthermore, the adhesives and sealants of the invention may be used for the manufacture and repair of industrial products or consumer products and also for sealing or adhesive bonding of components in construction or civil engineering and also, in particular, in the sanitary segment. The adherends may be, specifically, parts in automotive engineering, trailer construction, lorry construction, mobile home construction, train construction, aircraft construction, shipbuilding, and railway engineering.

An adhesive for elastic bonds in this area is applied preferably in the form of a bead in a substantially round or triangular cross-sectional area. Elastic bonds in vehicle construction are, for example, the attachment of parts such as plastic trim, decorative strips, flanges, bumpers, driver's cabs or other parts for attachment to the painted body of a means of transport or the bonded insertion of glazing sheets into the body.

A preferred area of application in construction and civil engineering is that of construction joints, floor joints, expansion joints or sealing joints in the sanitary segment. One preferred embodiment uses the described composition as an elastic adhesive or sealant. As an elastic adhesive, the composition typically has an elongation at break of at least 50% and as an elastic sealant it typically has an elongation at break of at least 300%, at room temperature.

For application of the composition as a sealant for, for example, joints in construction or civil engineering, or for application as an adhesive for elastic bonds in vehicle construction, for example, the composition preferably has a paste-like consistency with structurally viscous properties. A paste-like sealant or adhesive of this kind will be applied to the adherend by means of a suitable apparatus. Examples of suitable application methods include application from standard commercial cartridges, which are operated manually or by means of compressed air, or from a drum or hobbock by means of a conveying pump or an eccentric screw pump, if desired by means of an application robot.

The adherends may as and where necessary be pretreated prior to application of the adhesive or sealant. Such pretreatments include, in particular, physical and/or chemical cleaning methods, examples being abrading, sand-blasting, brushing or the like or treatment with cleaners or solvents or the application of an adhesion promoter, adhesion promoter solution or primer.

In the context of its use as an adhesive, the composition of the invention is applied either to one or the other adherend or to both adherends. Thereafter the parts to be bonded are joined, and the adhesive cures. It must in each case be ensured that the joining of the parts takes place within the formulated open time, in order to ensure that the two adherends are reliably bonded to one another.

The present invention further provides a process for preparing a composition, where a) polymer P and optionally at least one compound from the series consisting of filler, thixotropication, plasticizer, antioxidant and UV absorber is introduced, b) an amine component and optionally at least one compound from the series consisting of solvent and adhesion promoter is added, and c) boric acid and/or boric esters and optionally further components are added, the components being mixed homogeneously.

Where the composition is to be storable and where it comprises c) boric acid, the acid is preferably not admixed and is provided in the form of a second component and, where appropriate, mixed with further components.

It is, however, also possible to provide a one-component storable composition where c) comprises boric acid if the amine is latent amine or an encapsulated amine.

For the preparation process of the invention it is considered to be preferable that the components used are mixed with one another and/or kept in motion throughout the entire operation. Alternatively the components used may also be mixed homogeneously with one another only at the end of the preparation process. Suitable mixing equipment includes all of the apparatus known for this purpose to the skilled person, and more particularly the apparatus in question may be a static mixer, planetary mixer, horizontal turbulent mixer (from Drais), planetary dissolver or dissolver (from PC Laborsysteme), intensive mixer and/or extruder.

The process if the invention for preparing the composition may be carried out discontinuously in, for example, a planetary mixer. It is, however, also possible to operate the process continuously, in which case extruders in particular have been found suitable for this purpose. In this case, the binder is fed to the extruder, and both liquid and solid adjuvants are metered in.

A further aspect of the present invention is the use of boric acid and/or boric esters and an amine component as a condensation catalyst in the compositions of the invention. The application in question is preferably as an adhesive or sealant or as a coating.

Surprisingly it has been found that the compositions of the invention, in comparison to the prior art, exhibit an open time which can be adjusted over a wide range, and subsequently cure very rapidly. Moreover, in the case of the use of boric acid and amines, it is possible to cure the compositions of the invention independently of the ambient humidity, this being an advantage particularly at relatively high coat thicknesses. Through the provision of the composition of the invention, therefore, it has been possible to solve the stated problem in its entirety.

The examples which follow illustrate the advantages of the present invention.

### EXAMPLES

### Synthesis of the Silane-Terminated Polyurethane Prepolymer (SPU Prepolymer)

600 g of PPG 8000 (Acclaim® 8200, Bayer AG) are mixed with 28.34 g of isophorone diisocyanate (Vestanat IPDI, Evonik Industries AG) and the mixture is heated to 95° C. Then 150 ppm of catalyst (dibutyltin dilaurate, Air Products and Chemicals Inc.) are added dropwise with stirring. After 1.5 hours, again, 110 ppm of catalyst are added. After 2 hours, the NCO value (determined by titration) is 0.7%, and 0.103 mol of trialkoxysilane containing amino groups (N-butylaminopropyltrimethoxysilane, DN1189, Evonik Industries AG) is added. After 15 minutes, 1% by weight of vinyltrimethoxysilane (Dynasylan VTMO, Evonik Industries AG) is added and the system is left to cool slowly to RT. This gives a dear, colourless liquid.

### Synthesis of the Latent Hexylamine

20.0 g of methyl isobutyl ketone are dissolved in 100 ml of toluene and at 60-100° C. a solution of 20.2 g of hexylamine in 100 ml of toluene is slowly added dropwise and refluxed for 12 hours, in the course of which the water produced in the reaction is separated off with a water separator. Then the toluene is removed by distillation. This gives a brown liquid of low viscosity (34 g).

### Preparation of A Sealant With the SPU Prepolymer And Curing

### Composition of the Sealants

| Component | % by weight |
|---|---|
| Jayflex DIUP (Exxon Mobil Corp.) | 15 |
| Socal U1S2 (Solvay Chemicals GmbH) | 51 |
| Aerosil R202 (Evonik Industries AG) | 2 |
| SPU prepolymer | 30 |
| Dynasilan 1146 (Evonik Industries AG) | 1 |
| Dynasilan VTMO (Evonik Industries AG) | 1 |

The components are mixed homogeneously in succession using a Speedmixer™ at 3540 rpm for 90 seconds in each case; the catalyst is added last and mixing is continued at 3540 rpm for 60 seconds.

### Catalyst

| | |
|---|---|
| Comparative example 1 | 0.1% by weight BNT-CAT 440 (tin catalyst) |
| Comparative example 2 | 0.2% by weight BNT-CAT 440 (tin catalyst) |
| Inventive example 1 | 0.2% by weight boric acid in solution in |
| | 1.8% by weight ethanol, |
| | 0.2% by weight hexylamine |
| Inventive example 2 | 0.4% by weight boric acid in solution in |
| | 3.6% by weight ethanol, |
| | 0.2% by weight latent hexylamine |
| Inventive example 3 | 0.4% by weight boric acid in solution in |
| | 3.6% by weight ethanol, |
| | 0.2% by weight DBU |
| Inventive example 4 | 0.4% by weight triethyl borate |
| Inventive example 5 | 0.4% by weight triethyl borate, 0.2% by |
| | weight DBU |

The sealant is cured for 10 days at 23° C. and 50% relative humidity, test specimens are obtained by punching and the tensile strength is determined in accordance with DIN 53504.

The skin-forming time was determined as follows:

Approximately 2 g of sealant were applied to a plate in a thickness of approximately 1 cm and stored at 23° C. and in 50% relative humidity. By periodically contacting the surface of the sealant with the end of a wooden spatula, a determination was made of the point in time at which skin adhering to the tip of the spatula can be lifted up from the surface.

The through-cure rate was determined as follows:

The composition was applied to the recess in a Teflon mould having a wedge-shaped recess, and levelled off with a wooden spatula. After 24 hours at 23° C. and 50% relative humidity, starting from the thin end of the wedge, the adhesive, which had now crosslinked, was carefully lifted from the Teflon mould, up to the point (i.e. thickness) at which uncured adhesive was found on the inclined surface of the wedge recess. Because of the dimensions, it is possible in this way to determine the layer thickness of curing as a measure of the through-cure rate.

### Results

### Through-Curing (Wedge Length [cm])

| | Comparative | Comparative | Inventive | Inventive | Inventive | Inventive | Inventive |
|---|---|---|---|---|---|---|---|
| Day | example 1 | example 2 | example 1 | example 2 | example 3 | example 4 | example 5 |
| 0 | 0 | 0 | 0 | 0 | 0 | 0 | 0 |
| 1 | 10.2 | 9.3 | 11 | 0 | 30 | 0 | 9.8 |
| 2 | 13.5 | 13 | 19.5 | 30 | | 8 | 14.1 |
| 3 | 16.5 | 16.3 | 26.2 | | | 12.7 | 19 |
| 4 | 19.6 | 18.9 | 30 | | | 17.3 | 20.1 |
| 5 | 21.7 | 21.5 | | | | 18 | 21.7 |
| 6 | 26.6 | 25.8 | | | | 19.6 | 24.8 |
| 7 | 28.5 | 30 | | | | 21.8 | 28.5 |
| 8 | 30 | | | | | 26.4 | 30 |
| 9 | | | | | | 30 | |
| Skin-forming | 64 | 18 | >200 | >200 | 131 | >200 | 78 |
| time [min] | | | | | | | |
| Through- | 8 | 7 | 4 | 2 | 1 | 9 | 9 |
| curing | | | | | | | |
| wedge | | | | | | | |
| [days] | | | | | | | |
| Elongation | 265 | 257 | 191 | 174 | 326 | 153 | 292 |
| [%] | | | | | | | |
| Tensile | 2.4 | 2.4 | 2.8 | 2.9 | 3.0 | 2.0 | 3.0 |
| strength | | | | | | | |
| [N/mm2] | | | | | | | |
| Force at | 1.6 | 1.6 | 1.9 | 2.0 | 1.8 | 1.5 | 2.0 |
| 100% | | | | | | | |
| elongation | | | | | | | |
| [N/mm2] | | | | | | | |

1. Composition comprising
(A) at least 5% by weight of an organic prepolymer P having at least two water-crosslinkable organosilicon end groups,
(B) 0.01% to 3.0% by weight of boric acid and/or boric ester, and
(C) 0.01% to 3.0% by weight of an amine component.

2. The composition according to claim 1, wherein the prepolymer P comprises organosilicon end groups of the formula (I),
—Y—R¹—Si(R³)ₙ(OR²)₃₋ₙ (I)
where Y is represented by a divalent linking group,
R¹ is represented by a divalent hydrocarbon unit having 1 to 10 carbon atoms,
OR² is identical or different and independently at each occurrence is represented by an alkoxy group, where R² is an alkyl group having 1 to 10 carbon atoms and/or OR² is a phenoxy group, a naphthyloxy group, a phenoxy group which is substituted in the ortho, meta and/or para position by a C₁-C₂₀ alkyl, alkylaryl, alkoxy, phenyl, substituted phenyl, thioalkyl, nitro, halo, nitrile, carboxyalkyl, carboxyamide, —NH₂ and/or NHR⁴ group, in which R⁴ is a linear, branched or cyclic C₁-C₂₀ alkyl group,
R³ is identical or different and independently at each occurrence is represented by an alkyl, alkenyl, arylene, arylalkyl or alkylaryl having in each case 1 to 15 carbon atoms, it being optional for the radicals to contain oxygen and/or sulphur and/or nitrogen atoms, and n is represented by 0, 1 or 2.

3. The composition according to claim 2, wherein Y is represented by —N(C═O)—, —NR—, —NH— or —S— or organopolysiloxane,
R is represented by an alkyl group or aryl group having one to 20 carbon atoms,
OR² is identical or different and independently at each occurrence is represented by an alkoxy group, where R² is an alkyl group having 1 to 5 carbon atoms.

4. The composition according to claim 1, wherein the molar ratio of boric acid and/or boric esters to the amine component is 1:0.003 to 1:300.

5. The composition according to claim 1, wherein the boric ester is at least one compound from the group consisting of tri-C₁-C₆-alkyl borates, esters of diols, mixed boric esters of amino alcohols and diols, and esters of acids.

6. The composition according to claim 1, wherein the organic prepolymer P is at least one polymer compound based on acrylates, polyurethanes, polyureas, polyethers and polyesters.

7. The composition according to claim 1, wherein the amine component is at least one amine from the group consisting of butylamine, hexylamine, triethylamine, octylamine, laurylamine, dibutylamine, 3-(dimethylamino)-1-propylamine, diazabicyclooctane (DABCO), N-(2-hydroxyethoxyethyl)-2-azanorbornane, 1,8-diazabicyclo[5.4.0]undec-7-ene (DBU) and 1,5-diazabicyclo [4.3.0]non-5-ene and/or at least one latent amine from the group consisting of ketimines, aldimines, enamines and oxazolidines.

8. The composition according to claim 1, wherein the composition comprises at least one further ingredient from the group consisting of auxiliaries, additives, dispersants, film-forming assistants, pigments, rheological assistants, water scavengers, adhesion promoters, catalysts, plasticizers, light stabilizers, ageing inhibitors, flame retardants and/or biocides.

9. The composition according to claim 1, wherein the composition is an adhesive or sealant or a coating.

10. Method for curing a composition according to claim 1, where (B) is boric acid, which is present separately from the amine component (C) in a two-component system and the components are mixed with one another.

11. Method for curing a composition according to claim 10, the curing being carried out in the absence of ambient moisture.

12. Method for curing a composition according to claim 1, where (B) is boric ester, and the composition is in the form of a one-component system and is exposed to the ambient moisture.

13. Method for curing a composition according to claim 1, where (B) is boric acid, which is enclosed in a matrix, the composition is in the form of a one-component system, and the composition is subjected to conditions under which the boric acid is released from the matrix.

14. Method for curing a composition according to claim 1, where the amine component (C) is enclosed in a matrix, the composition is in the form of a one-component system, and the composition is subjected to conditions under which the amine component (C) is released from the matrix.

15. A condensation catalyst comprising boric acid and/or boric esters and an amine component used in a composition according to claim 1.
